(19) United States
(12) Patent Application Publication
(10) Pub. No.: US 2026/0088220 A1
(43) Pub. Date: Mar. 26, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Gil Seong Kang, Suwon-si (KR); Sun-Min Jung, Suwon-si (KR); Jiyoung Lee, Suwon-si (KR); Yongjun Gong, Suwon-si (KR); Chanhee Nam, Suwon-si (KR); Heesun Chun, Suwon-si (KR)

(73) Assignee: SAMSUNG ELECTRO-MECHANICS CO., LTD., Suwon-si (KR)

(21) Appl. No.: 19/064,490

(22) Filed: Feb. 26, 2025

(30) Foreign Application Priority Data
Sep. 23, 2024 (KR) 10-2024-0128179

(51) Int. Cl. H01G 4/008; H01G 4/12; H01G 4/232; H01G 4/248; H01G 4/30

(52) U.S. Cl. CPC H01G 4/008; H01G 4/1227; H01G 4/1245; H01G 4/232; H01G 4/248; H01G 4/30

(57) ABSTRACT

A multilayer ceramic capacitor including a capacitor body including a plurality of dielectric layers and a plurality of internal electrode layers stacked with the dielectric layers interposed therebetween; and an external electrode disposed on an outer surface of the capacitor body, wherein the internal electrode layers include tin (Sn), the dielectric layers include one or more elements (X) selected from bismuth (Bi), aluminum (Al), gallium (Ga), and indium (In), a content of the tin (Sn) is higher at an interface with the dielectric layers than at a center region of the internal electrode layers in a stacking direction in the internal electrode layers, and a content of the element (X) is higher at an interface with the internal electrode layers than at a center region of the dielectric layers in a stacking direction in the dielectric layers.

### CROSS-REFERENCE TO RELATED APPLICATION

This application claims priority to and the benefit of Korean Patent Application No. 10-2024-0128179 filed in the Korean Intellectual Property Office on Sep. 23, 2024, the entire contents of which are incorporated herein by reference.

### BACKGROUND

### (a) Technical Field

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

The dielectric is mainly a ferroelectric material, such as BaTiO₃, which has a high permittivity at room temperature and excellent insulation resistance, and the electrode material is a metal such as Ni, which has excellent conductivity and is inexpensive. As technology advances, MLCCs are required to be miniaturized and have higher capacities. Recently, as the demand for MLCCs for battlefields directly related to passenger safety has increased, high reliability, including product life-span and technological stability, is required.

### SUMMARY

An embodiment provides a multilayer ceramic capacitor having excellent density and reliability.

Another embodiment provides a method of manufacturing a multilayer ceramic capacitor.

An embodiment provides a multilayer ceramic capacitor that includes a capacitor body including a plurality of dielectric layers and a plurality of internal electrode layers stacked along a stacking direction, wherein at least one dielectric layer among the dielectric layers is interposed therebetween adjacent internal electrode layers among the internal electrode layers; and an external electrode disposed on an outer surface of the capacitor body, wherein at least one of the internal electrode layers include tin (Sn), the at least one dielectric layer includes an element (X), wherein the element (X) is at least one selected from bismuth (Bi), aluminum (Al), gallium (Ga), and indium (In), a content of tin (Sn) is higher at an interface of the at least one of the internal electrode layers with the at least one dielectric layer than at a center region of the at least one of the internal electrode layers in the stacking direction, and a content of the element (X) is higher at the interface than at a center region of the at least one dielectric layer in the stacking direction.

The interface includes tin (Sn) in a form of SnO₂.

The at least one of the internal electrode layers may further include nickel (Ni).

The interface may include the element (X) in a form of an intermetallic compound with nickel (Ni).

The at least one of the internal electrode layers may further include nickel (Ni), the interface may include tin (Sn) in a form of SnO₂, and the interface may include the element (X) in a form of an intermetallic compound with nickel (Ni).

The at least one of the internal electrode layers may further include the element (X).

In the at least one of the internal electrode layers, a content of the element (X) may be higher at the interface than at the center region of the at least one of the internal electrode layers.

The at least one dielectric layer may further include tin (Sn).

In the at least one dielectric layer, a content of tin (Sn) may be higher at the interface than at the center region of the at least one dielectric layer in the stacking direction.

When analyzing a transmission electron microscope-energy dispersive spectroscopy (TEM-EDS) line along a straight line from a point on the at least one dielectric layer to a point on an internal electrode layer adjacent to the at least one dielectric layer, atomic % of tin (Sn) may have a maximum value at the interface.

When analyzing a transmission electron microscope-energy dispersive spectroscopy (TEM-EDS) line along a straight line from a point on the at least one dielectric layer to a point on an internal electrode layer adjacent to the at least one dielectric layer, atomic % of bismuth (Bi) may have a maximum value at the interface.

An average thickness of the interface may be 0.01 nm to 100 nm.

The at least one dielectric layer may further include a barium titanate-based compound, and the barium titanate-based compound may include at least one selected from BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, and (Ba, Sr)(Ti, Sn)O₃.

The at least one dielectric layer may include pores with an area of less than about 1% per an area of 5 μm×5 μm within the at least one dielectric layer.

Another embodiment provides a method of manufacturing a multilayer ceramic capacitor which includes: mixing barium titanate-based main component powder and subcomponent powder to prepare a dielectric slurry; preparing a conductive paste by mixing nickel (Ni) and tin (Sn)-containing compound; manufacturing a dielectric green sheet from the dielectric slurry and applying the conductive paste on a surface of the dielectric green sheet to form a conductive paste layer; manufacturing a dielectric green sheet stack by stacking a plurality of the dielectric green sheet on which the conductive paste layer is formed; manufacturing a capacitor body including a dielectric layer and an internal electrode layer by firing the dielectric green sheet stack; and forming an external electrode on one surface of the capacitor body, wherein the subcomponent powder includes at least one selected from a bismuth (Bi)-containing compound, an aluminum (Al)-containing compound, a gallium (Ga)-containing compound, and an indium (In)-containing compound, the internal electrode layer includes tin (Sn), the dielectric layer includes an element (X), where the element (X) is at least one selected from bismuth (Bi), aluminum (Al), gallium (Ga), and indium (In), a content of tin (Sn) is higher at an interface of the internal electrode layer with the dielectric layer than at a center region of the internal electrode layer in a stacking direction, and a content of the element (X) is higher at the interface than at a center region of the dielectric layer in the stacking direction.

The tin (Sn)-containing compound may include an oxide, a nitride, or a salt compound, or the tin (Sn)-containing compound may include a sol form dispersed in an organic solvent.

The bismuth (Bi)-containing compound, the aluminum (Al)-containing compound, the gallium (Ga)-containing compound, and the indium (In)-containing compound may each include an oxide, a nitride, a salt compound, or the bismuth (Bi)-containing compound, the aluminum (Al)-containing compound, the gallium (Ga)-containing compound, and the indium (In)-containing compound may each include a sol form dispersed in an organic solvent.

The tin (Sn)-containing compound may be mixed with nickel (Ni) in an amount of greater than about 0.1 parts by mole and less than or equal to about 5 parts by mole based on 100 parts by mole of the barium titanate-based main component powder.

The subcomponent powder may be mixed in an amount of greater than about 0.1 parts by mole and less than or equal to about 5 parts by mole based on 100 parts by mole of the barium titanate-based main component powder.

A molar ratio of the tin (Sn)-containing compound to the subcomponent powder is 0.1 to 1.

The multilayer ceramic capacitor according to an embodiment of the present application can improve internal electrode deterioration and electrode connectivity by implementing low-temperature firing of a dielectric, as well as enhance density and reliability.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 is a schematic diagram showing a cross-section of a portion of an active region according to an embodiment.

FIG. 6 is a phase diagram of Sn and Bi.

FIG. 7 is a graph showing the leakage current degradation behavior of each of a Ni—Sn electrode in a multilayer ceramic capacitor and a Ni electrode in a multilayer ceramic capacitor.

FIG. 8A is a TEM (transmission electron microscope) micrograph of a portion of the active region according to Example 2. FIGS. 8B and 8C are each a TEM line profile image of the portion of the active region according to Example 2.

FIG. 9 is a SEM (scanning electron microscope) analysis image of a portion of the active region according to Example 2.

FIG. 10 is a SEM (scanning electron microscope) analysis image of a portion of the active region according to Comparative Example 6.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

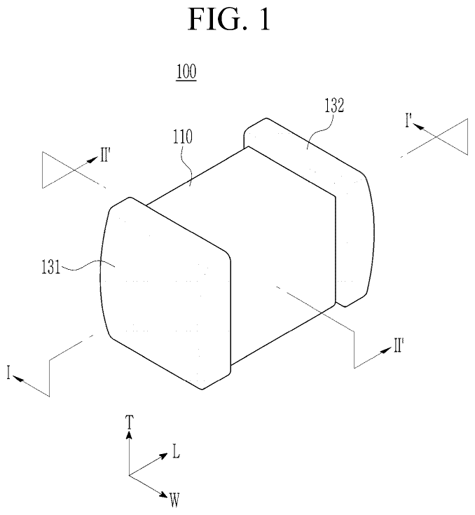

Hereinafter, a multilayer ceramic capacitor according to an embodiment will be described with reference to FIGS. 1 to 4.

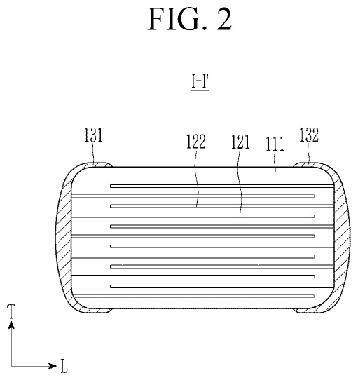

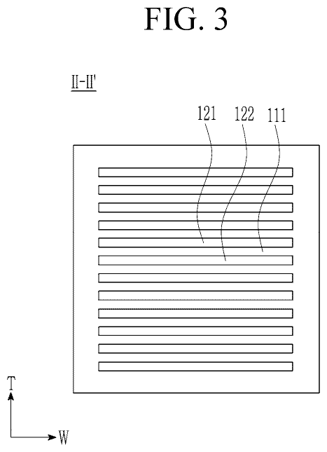

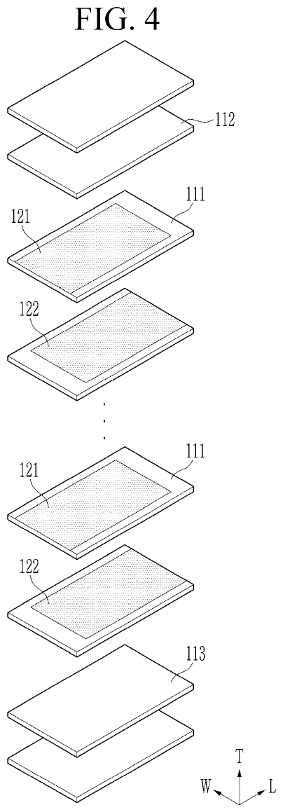

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outside the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be located on opposite side ends of the active region in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin region serve to prevent damage to the first internal electrode layer 121 and the second internal electrode layer 122 due to physical or chemical stress.

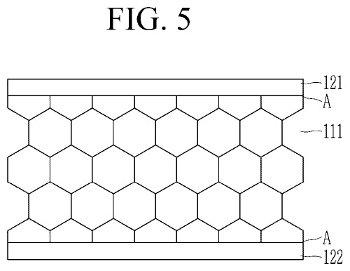

The active region of the capacitor body 110 is described in detail with reference to FIG. 5.

FIG. 5 is a schematic diagram showing a cross-section of a portion of an active region according to an embodiment.

Referring to FIG. 5, the active region of the capacitor body 110 according to an embodiment may include a dielectric layer 111 and internal electrode layers 121 and 122.

The internal electrode layers 121 and 122 may include tin (Sn).

The internal electrode layers 121 and 122 may have a center region and an interface A with the dielectric layer 111 in the stacking direction. In the internal electrode layers 121 and 122, the center region is a region disposed inside the interface A between the internal electrode layers 121 and 122 and the dielectric layer 111 in the stacking direction, and the interface A with the dielectric layer 111 is a region disposed outside the center region in the stacking direction as the interface between the internal electrode layers 121 and 122 and the dielectric layer 111.

Tin (Sn) can exist both in the center region and at the interface A of the internal electrode layers 121 and 122. Specifically, a content of tin (Sn) may be higher at the interface A with the dielectric layer 111 than at the center region of the internal electrode layers 121 and 122. A content of tin (Sn) may mean the atomic % of the total amount of elements in each region.

The dielectric layer 111 may include one or more elements (X) selected from bismuth (Bi), aluminum (Al), gallium (Ga), and indium (In).

The dielectric layer 111 may have a center region and an interface A with internal electrode layers 121 and 122 in the stacking direction. In the dielectric layer 111, the center region is a region disposed inside the interface A between internal electrode layers 121 and 122 and the dielectric layer 111 in the stacking direction, and the interface A with internal electrode layers 121 and 122 is a region disposed outside the center region in the stacking direction as the interface between internal electrode layers 121 and 122 and the dielectric layer 111.

The element (X) can exist both in the center region and the interface A of the dielectric layer 111. Specifically, a content of element (X) may be higher at the interface A with internal electrode layers 121 and 122 than at the center region of the dielectric layer 111. The content of elements (X), such as bismuth (Bi), may mean the atomic % of the total amount of elements in each region.

In general, the reliability of multilayer ceramic capacitors is reduced by current leakage due to disconnection and deterioration of internal electrodes such as Ni, and the occurrence and movement of oxygen vacancies. Specifically, since dielectrics such as BaTiO₃ are fired at a high temperature that can cause internal electrodes to shrink, internal electrodes deteriorate, and firing in a reducing atmosphere to prevent oxidation of internal electrodes causes oxygen vacancies in BaTiO₃, which causes reliability deterioration. Accordingly, it is important to secure a multilayer ceramic capacitor with high reliability by lowering the firing temperature to minimize firing mismatch between BaTiO₃ and Ni internal electrodes and suppressing the generation and movement of oxygen vacancies.

According to an embodiment, when the content of tin (Sn) is higher at the interface A than at the center region in the internal electrode layers 121 and 122, and the content of an element (X) such as bismuth (Bi) is higher at the interface A than at the center region in the dielectric layer 111, low-temperature firing of the dielectric due to a low melting point can be implemented, thereby improving internal electrode deterioration and enhancing internal electrode connectivity. In addition, by reducing the movement of oxygen vacancies through the formation of a Schottky barrier and reduction of leakage current, a multilayer ceramic capacitor with excellent density and reliability can be secured even under low-temperature firing.

The element (X) included in the dielectric layer 111 may be, for example, bismuth (Bi).

Since bismuth (Bi) has lower oxidation properties than nickel (Ni) and tin (Sn), it can also play a role in preventing oxidation of tin (Sn) and nickel (Ni) at the interface A between the dielectric layer 111 and the internal electrode layers 121 and 122.

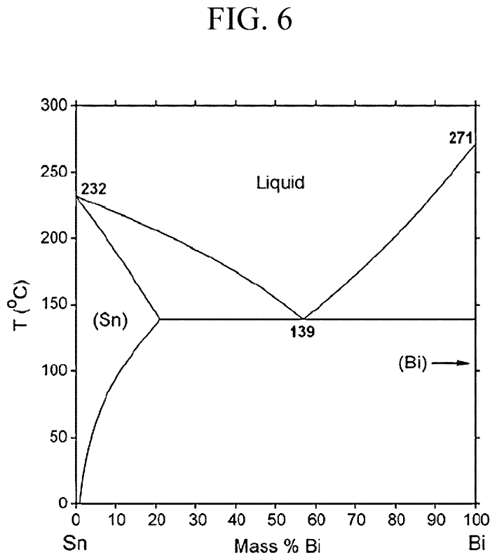

FIG. 6 is a phase diagram of Sn and Bi.

Referring to FIG. 6, it can be seen that tin (Sn) and bismuth (Bi) included in the interface A between the dielectric layer 111 and internal electrode layers 121 and 122 have a low melting point of 139° C. or less, and thus low-temperature firing of the dielectric can be implemented.

The tin (Sn) can be derived from Sn-containing compounds such as SnO₂, which are used in forming the internal electrode layer. The SnO₂ component in the internal electrode layer may diffuse into the dielectric layer 111 after firing and exist mainly in the form of SnO₂ oxide at the interface A. In other words, the tin (Sn) may be included in the form of an oxide of SnO₂ at the interface A with the dielectric layer 111. The presence of SnO₂ may be determined by TEM-EDS (transmission electron microscope-energy dispersive spectroscopy). Other methods and/or tools appreciated by one of ordinary skill in the art, even if not described in the present disclosure, may also be used.

The element (X), such as bismuth (Bi), may be derived from an element (X)-containing compound, such as a Bi-containing compound, such as Bi₂O₃, which are added during the formation of the dielectric layer. As the element (X)-containing compound component in the dielectric layer diffuses into the internal electrode layers 121 and 122 after firing, the element (X) may exist mainly at the interface A.

Additionally, the internal electrode layers 121 and 122 may further include nickel (Ni). The element (X) such as bismuth (Bi) may be included in the form of an intermetallic compound with reduced nickel (Ni) at the interface A with the internal electrode layers 121 and 122.

The internal electrode layers 121 and 122 may further include one or more conductive metals selected from among copper (Cu), silver (Ag), palladium (Pd), gold (Au), and alloys thereof, in addition to nickel (Ni).

Elements present in internal electrode layers 121 and 122 and the dielectric layer 111, and the concentration gradient of elements in each layer can be confirmed through a TEM-EDS (transmission electron microscope-energy dispersive spectroscopy) line profile.

In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active region of the cross-sectional sample can be measured using a transmission electron microscope (TEM) so that at least one layer, for example, eight or more layers of the dielectric layer 111 and internal electrode layers 121 and 122 are visible. For example, TEM can be measured under conditions of an acceleration voltage of 200 kV using Xe-FIB (focused ion beam) for an active region including an area of about 7 μm×7 μm in which at least eight layers of dielectric layers 111 and internal electrode layers 121 and 122 are visible. Next, by performing EDS (Energy Dispersive Spectroscopy) line analysis on the TEM image of the measured cross-sectional sample, it is possible to confirm both the elements present in the internal electrode layer and dielectric layer and the concentration gradient of the elements in each layer. For example, in a TEM image of a cross-sectional sample, when the active region is divided into three parts, the upper part, the middle part, and the lower part, three straight sections are taken for each region from a point on the dielectric layer to a point on the internal electrode layer adjacent to the dielectric layer, and TEM-EDS line analysis may be performed on a total of nine sections.

Specifically, when analyzing a TEM-EDS (transmission electron microscope-energy dispersive spectroscopy) line for a straight section from one point in the dielectric layer to one point in the internal electrode layer adjacent to the dielectric layer, the atomic % of tin (Sn) can have a maximum value at the interface A between the dielectric layer 111 and the internal electrode layers 121 and 122.

In addition, when analyzing a TEM-EDS (transmission electron microscope-energy dispersive spectroscopy) line for a straight section from one point of the dielectric layer to one point of the internal electrode layer adjacent to the dielectric layer, the atomic % of bismuth (Bi) can have a maximum value at the interface A between the dielectric layer 111 and internal electrode layers 121 and 122.

Other methods and/or tools appreciated by one of ordinary skill in the art, even if not described in the present disclosure, may also be used to determine the elements present in internal electrode layers 121 and 122 and the dielectric layer 111, and the concentration gradient of such elements.

The average thickness of the interface A between the dielectric layer 111 and internal electrode layers 121 and 122 may be about 0.01 nm to about 100 nm, for example, about 0.05 nm to about 90 nm, or about 0.1 nm to about 80 nm. The average thickness of the interface A may be measured by scanning electron microscope (SEM) analysis. Here, the scanning electron microscope (SEM) analysis is identical to the above-described average thickness measurement method of the dielectric layer 111, so that its description is omitted. Other methods and/or tools appreciated by one of ordinary skill in the art, even if not described in the present disclosure, may also be used.

Hereinafter, the dielectric layer 111 and internal electrode layers 121 and 122 are described in more detail.

The dielectric layer 111 includes a barium titanate-based compound.

The barium titanate-based compound is a dielectric base material, has a high dielectric constant, and contributes to forming the dielectric constant of a multilayer ceramic capacitor 100.

The barium titanate-based compound is a compound including barium (Ba) and titanium (Ti), and may include, for example, BaTiO₃, Ba(Ti, Zr)O₃, Ba(Ti, Sn)O₃, (Ba, Ca)TiOs, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The dielectric layer 111 may further include tin (Sn) in addition to the element (X) such as bismuth (Bi) described above.

Specifically, a content of tin (Sn) may be higher at the interface A with internal electrode layers 121 and 122 than at a center region of the dielectric layer 111. When the content of tin (Sn) is higher at the interface A than at the center region in the dielectric layer 111, low-temperature firing of the dielectric may be implemented to improve internal electrode deterioration and enhance internal electrode connectivity, and a multilayer ceramic capacitor with excellent density and reliability can be secured even under low-temperature firing.

Additionally, the dielectric layer 111 may further include one or more additional components selected from magnesium (Mg), silicon (Si), vanadium (V), terbium (Tb), and dysprosium (Dy).

An average thickness (average length in the T-axis direction) of the dielectric layer 111 may be about 2.0 μm to about 8.0 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 may be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of dielectric layers 111. This may be an arithmetic mean value obtained by taking the central point of the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted.

The dielectric layer 111 according to an embodiment may not include pores, and even if it includes pores, it may include an area of less than about 1%, for example, less than about 1% per 5 μm×5 μm area within the dielectric layer of the total area of the dielectric layer. For example, the dielectric layer 111 may include pores in an area of about 0 to about 0.9%, about 0.01 to about 0.8%, about 0.05 to about 0.7%, or about 0.07 to about 0.6% of the total area of the dielectric layer. When the dielectric layer includes pores in an area within the above range, a multilayer ceramic capacitor having excellent density and thus high reliability can be secured.

The area of the pores may be confirmed through scanning electron microscope (SEM) analysis. Other methods and/or tools appreciated by one of ordinary skill in the art, even if not described in the present disclosure, may also be used.

In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active region of the cross-sectional sample can be measured using SEM so that at least one layer, for example, four or more layers of the dielectric layer 111 and internal electrode layers 121 and 122 are visible. For example, SEM may be measured under conditions of an acceleration voltage of 2.0 kV in an area of about 5 μm×5 μm in which at least four layers of dielectric layers 111 and internal electrode layers 121 and 122 are visible in the active region. SEM images of the measured cross-sectional samples reveal the presence of pores and their areas within the dielectric layer.

The internal electrode layers 121 and 122, i.e., the first internal electrode layer 121 and the second internal electrode layer 122, are electrodes having different polarities and are alternately arranged to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

As described above, the internal electrode layers 121 and 122 includes a conductive metal including nickel (Ni) and tin (Sn), so that leakage current is reduced, thereby reducing the movement of oxygen vacancies, and thus improving density and reliability.

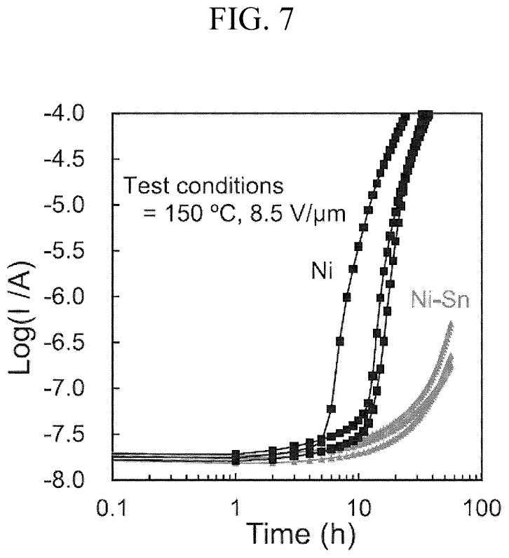

FIG. 7 is a graph showing the leakage current degradation behavior of a Ni−Sn electrode in a multilayer ceramic capacitor.

Referring to FIG. 7, it can be seen that the leakage current is reduced in the case of the Ni−Sn internal electrode using Ni and Sn together compared to the Ni internal electrode.

The internal electrode layers 121 and 122 may further include a conductive metal including nickel (Ni) and, in addition to tin (Sn), one or more elements (X) selected from bismuth (Bi), aluminum (Al), gallium (Ga), and indium (In).

Specifically, the content of the element (X) may be higher at the interface A with the dielectric layer 111 than at the center region of the internal electrode layers 121 and 122. When the content of elements (X) such as bismuth (Bi) is higher at the interface A than at the center region in internal electrode layers 121 and 122, not only can low-temperature firing of the dielectric be implemented to improve internal electrode deterioration and enhance internal electrode connectivity, but also a multilayer ceramic capacitor with excellent density and reliability can be secured even under low-temperature firing.

Additionally, the internal electrode layers 121 and 122 may further include one or more additional components selected from magnesium (Mg), silicon (Si), vanadium (V), terbium (Tb), and dysprosium (Dy).

Additionally, the internal electrode layers 121 and 122 may include dielectric particles having the same composition as the ceramic material included in the dielectric layer 111.

The internal electrode layers 121 and 122 can be formed using a conductive paste including a conductive metal including nickel (Ni) and tin (Sn). The printing method for the conductive paste can be either screen printing or gravure printing.

Each average thickness of the first internal electrode layer 121 and the second internal electrode layer 122 may be about 0.1 μm to about 2 μm. The average thickness of the first internal electrode layer 121 and the second internal electrode layer 122 may be measured by scanning electron microscope (SEM) analysis. Here, scanning electron microscope (SEM) analysis is applied in the same way as the average thickness measurement method of the dielectric layer 111 described above, so its description is omitted.

The capacitor body 110 may be formed by firing a stacking structure in which the plurality of dielectric layers 111 and internal electrode layers 121 and 122 are stacked.

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

Hereinafter, a method of manufacturing the multilayer ceramic capacitor 100 according to an embodiment will be described.

A multilayer ceramic capacitor 100 according to an embodiment may be manufactured by mixing barium titanate-based main component powder and subcomponent powder to prepare a dielectric slurry; preparing a conductive paste by mixing a nickel (Ni) and tin (Sn)-containing compound; manufacturing a dielectric green sheet using the dielectric slurry and printing the conductive paste on a surface of the dielectric green sheet to form a conductive paste layer; manufacturing a dielectric green sheet stack by stacking the dielectric green sheet on which the conductive paste layer is formed; manufacturing a capacitor body including a dielectric layer and an internal electrode layer by firing the dielectric green sheet stack; and forming an external electrode on one surface of the capacitor body.

The barium titanate-based main component powder is a compound including barium (Ba) and titanium (Ti), and may include, for example one or more selected from BaTiO₃, Ba(Ti, Zr)O₃, Ba(Ti, Sn)O₃, (Ba, Ca)TiOs, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, and (Ba, Sr)(Ti, Sn)O₃.

The subcomponent powder may include at least one selected from a bismuth (Bi)-containing compound, an aluminum (Al)-containing compound, a gallium (Ga)-containing compound, and an indium (In)-containing compound.

Additionally, the subcomponent powder may further include one or more selected from a Mg-containing compound, a Si-containing compound, a V-containing compound, a Tb-containing compound, and a Dy-containing compound.

Each of the subcomponent powders can be mixed in an amount of greater than about 0.1 parts by mole and less than or equal to about 5 parts by mole, for example, about 0.2 parts by mole to about 4.5 parts by mole, about 0.4 parts by mole to about 4 parts by mole, about 0.6 parts by mole to about 3.5 parts by mole, or about 0.8 parts by mole to about 3.0 parts by mole based on 100 parts by mole of the barium titanate-based main component powder. When the subcomponent powder is mixed within the above content range, low-temperature firing of the dielectric may be implemented to improve internal electrode deterioration and enhance internal electrode connectivity, and the density and reliability can be improved by reducing the movement of oxygen vacancies through the formation of a Schottky barrier and reduction of leakage current.

The subcomponent powders, i.e., Bi-containing compounds, Al-containing compounds, Ga-containing compounds, In-containing compounds, etc., may each be in the form of an oxide, a nitride, a salt compound, or a sol form dispersed in an organic solvent.

The dielectric slurry may be prepared by additionally mixing additives such as a dispersant, a binder, a plasticizer, a lubricant, an antistatic agent, and a solvent.

The dispersant may include for example a phosphoric acid ester-based dispersant, a polycarboxylic acid-based dispersant, or a combination thereof. The dispersant may be mixed in an amount of about 0.1 part by weight to about 5 parts by weight, for example, about 0.3 parts by weight to about 3 parts by weight based on 100 parts by weight of the barium titanate-based main component powder. When the dispersant is mixed within the above content range, the dielectric slurry shows excellent dispersibility, and the amount of impurities included in the manufactured dielectric layer may be reduced.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based main component powder. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based main component powder. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based main component powder. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

The conductive paste may be prepared by mixing nickel (Ni) and tin (Sn) containing compounds.

In addition to nickel (Ni), the conductive paste may be prepared by further mixing one or more conductive metals selected from copper (Cu), silver (Ag), palladium (Pd), gold (Au), and an alloy thereof.

The tin (Sn)-containing compound may include an oxide, nitride, salt compound of tin (Sn), or a sol form dispersed in an organic solvent.

The tin (Sn)-containing compound may be mixed in an amount of greater than about 0.1 parts by mole and less than or equal to about 5 parts by mole, for example, about 0.2 parts by mole to about 4.5 parts by mole, about 0.4 parts by mole to about 4 parts by mole, about 0.6 parts by mole to about 3.5 parts by mole, or about 0.8 parts by mole to about 3.0 parts by mole based on 100 parts by mole of the barium titanate-based main component powder. When a tin (Sn)-containing compound is included in the above content range, the movement of oxygen vacancies can be reduced through a reduction in leakage current, thereby improving density and reliability.

The tin (Sn)-containing compound and the subcomponent powder can be mixed so that the molar ratio of the tin (Sn)-containing compound to the subcomponent powder may be about 0.1 to about 1, for example, about 0.12 to about 0.98, about 0.14 to about 0.96, about 0.16 to about 0.94, about 0.18 to about 0.92, or about 0.2 to about 0.9. When the molar ratio of the subcomponent powder to the tin (Sn)-containing compound is within the above range, low-temperature firing of the dielectric is realized, thereby improving internal electrode deterioration and enhancing electrode connectivity, and also improving the density and reliability of the multilayer ceramic capacitor even under low-temperature firing.

The conductive paste may additionally include a binder and a solvent.

Additionally, a barium titanate powder may be mixed in as a co-material if necessary. The co-material may act to suppress sintering of the conductive powder during the firing process. In the step of manufacturing the dielectric green sheet, a dielectric slurry may be prepared by mixing a barium titanate-based compound as a main component powder and optionally a subcomponent powder.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcining) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 10 and Comparative Examples 1 to 6

A dielectric slurry was prepared by mixing barium titanate (BaTiO₃) as the main component powder and bismuth oxide (Bi₂O₃) as the subcomponent powder. At this time, Bi₂O₃ was mixed so that Bi had the content shown in Table 1 based on 100 parts by mole of the main component powder BaTiO₃.

In the preparation of the dielectric slurry, zirconia balls (ZrO₂ balls) was used as a dispersion medium, and ethanol/toluene, a wetting dispersant, and a polyvinyl butyral (PVB) resin as a binder were added thereto and then, mechanically milled.

The prepared dielectric slurry was used to manufacture a dielectric green sheet by using a head discharge type on-roll forming coater.

On the surface of the dielectric green sheet, a conductive paste including Ni and SnO₂ was printed to form a conductive paste layer, and more than one dielectric green sheet having the conductive paste layer was stacked and compressed to manufacture a dielectric green sheet stack. Herein, SnO₂ was mixed in each amount shown in Table 1 based on 100 parts by mole of the BaTiO₃ main component powder.

The dielectric green sheet stack was calcinated at 400° C. or less under a nitrogen atmosphere and fired at 1300° C. or less at a hydrogen (H₂) concentration of 1.0% or less.

Subsequently, the dielectric green sheet stack was used to manufacture a multilayer ceramic capacitor through processes of an external electrode, plating, or the like.

In Table 1, Bi and Sn contents were expressed based on 100 parts by mole of the BaTiO₃ main component powder.

TABLE 1

| | | | Bi/Sn | Firing |
|---|---|---|---|---|
| | Bi (parts | Sn (parts | molar | temperature |
| | by mole) | by mole) | ratio | (° C.) |
| Example 1 | 0.2 | 1 | 0.2 | 1240 |
| Example 2 | 0.4 | 1 | 0.4 | 1230 |
| Example 3 | 0.6 | 1 | 0.6 | 1230 |
| Example 4 | 0.8 | 1 | 0.8 | 1220 |
| Example 5 | 1 | 1 | 1 | 1220 |
| Example 6 | 0.2 | 2 | 0.1 | 1240 |
| Example 7 | 0.4 | 2 | 0.2 | 1240 |
| Example 8 | 0.6 | 2 | 0.3 | 1240 |
| Example 9 | 0.8 | 2 | 0.4 | 1230 |
| Example 10 | 1 | 2 | 0.5 | 1230 |
| Comparative Example 1 | 0.2 | 0 | 0 | 1250 |
| Comparative Example 2 | 0.4 | 0 | 0 | 1250 |
| Comparative Example 3 | 0.6 | 0 | 0 | 1250 |
| Comparative Example 4 | 0.8 | 0 | 0 | 1250 |
| Comparative Example 5 | 1 | 0 | 0 | 1240 |
| Comparative Example 6 | 0 | 1 | 0 | 1240 |

### Evaluation 1: TEM-EDS Line Profile

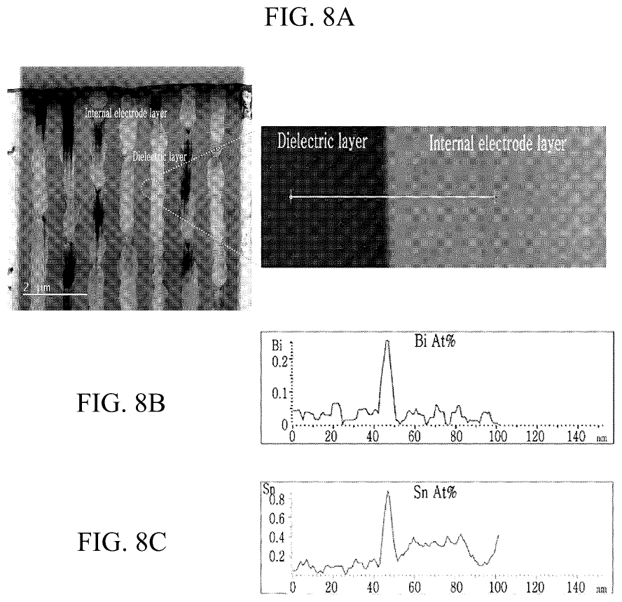

The multilayer ceramic capacitors of Examples 1 to 10 and Comparative Examples 1 to 6 were subjected to TEM-EDS (transmission electron microscope-energy dispersive spectroscopy) line profile, and the results are shown in FIGS. 8A to 8C.

Specifically, after the multilayer ceramic capacitors were put into an epoxy mixture and cured, the W-axis and T-axis direction surface (WT surface) of each capacitor body was polished to a depth of ½ in the L-axis direction and then, fixed and maintained in a vacuum atmosphere chamber to obtain cross-sectional samples to observe an active region where a dielectric layer and an internal electrode layer intersect each other. Subsequently, the cross-sectional samples were measured with TEM (transmission electron microscope) with respect to an active region including an area of about 7 μm×7 μm wherein at least 8 dielectric layers and internal electrode layers were visible by using Xe-FIB (focused ion beam) at an acceleration voltage of 200 kV. Subsequently, in the TEM image of the cross-sectional sample, the active region was divided into three portions such as upper, central, and lower parts, and the TEM-EDS line analysis was performed by taking an image of three sections per each part, that is, total 9 sections in a straight line from one point of the dielectric layer to one point of the internal electrode layer neighboring the dielectric layer.

FIG. 8A is a TEM (transmission electron microscope) micrograph of a portion of the active region according to Example 2. FIGS. 8B and 8C are each a TEM line profile image of the portion of the active region according to Example 2.

Referring to FIGS. 8A to 8C, as a result of examining the active region of the multilayer ceramic capacitor of Example 2, it was confirmed that Sn existed in the internal electrode layer, while Bi existed in the dielectric layer, wherein Sn existed in a higher content on the interface with the dielectric layer than the central part of the internal electrode layer, Bi existed in a higher content on the interface with the internal electrode layer than in the central part of the dielectric layer.

### Evaluation 2: SEM Analysis

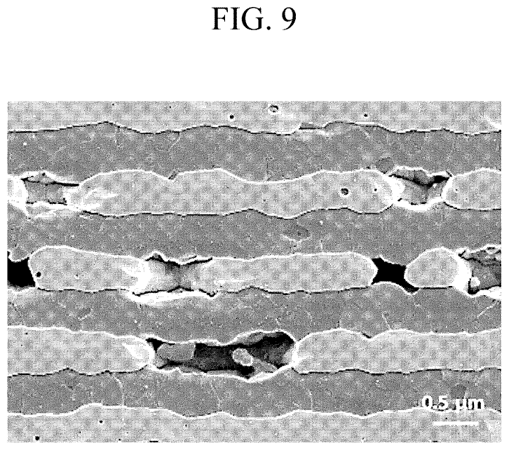

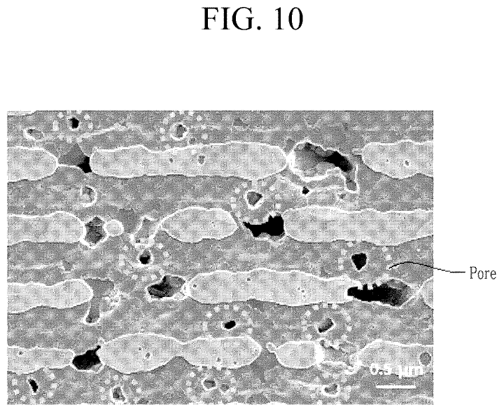

The multilayer ceramic capacitors according to Examples 1 to 10 and Comparative Examples 1 to 6 were subjected to SEM (scanning electron microscope) analysis, and the results are shown in FIGS. 9 and 10 and Table 2.

Specifically, the active region of the cross-sectional sample obtained in Evaluation 1 was measured with respect to an area of about 5 μm×5 μm where at least four dielectric layers and internal electrode layers were visible by using SEM at an acceleration voltage of 2.0 kV. The SEM image of the cross-sectional sample was used to check density of the dielectric layer.

FIG. 9 is a SEM (scanning electron microscope) analysis image of a portion of the active region according to Example 2, and FIG. 10 is a SEM (scanning electron microscope) analysis image of a portion of the active region according to Comparative Example 6.

Referring to FIGS. 9 and 10, the dielectric layer of Example 2 exhibited almost no pores and thus high density, but the dielectric layer of Comparative Example 6 had a large area of pores and thus low density. Accordingly, the multilayer ceramic capacitor according to an embodiment may have a dielectric layer with excellent density even under low temperature firing.

On the other hand, after calculating an area of pores in the SEM image, when the pore area was 1% or more per the area of 5 μm×5 μm in the dielectric layer, the density was judged to be X, but when the pore area was less than 1%, the density was judged to be O, and the results are shown in Table 2.

### Evaluation 3: Reliability

The accelerated life-span reliability (MTTF) of the multilayer ceramic capacitors manufactured in Examples 1 to 10 and Comparative Examples 1 to 6 was measured by the following method, and the results are shown in Table 2.

MTTF (mean time to failure) was measured as hours (hr) at a voltage of 9.45 V for 48 hours at a temperature of 125° C.

In Table 2, the MTTF values were expressed as a ratio based on the result of Comparative Example 5.

TABLE 2

| | Firing temperature | | |
|---|---|---|---|
| | (° C.) | Density | MTTF |
| Example 1 | 1240 | ◯ | 1.23 |
| Example 2 | 1230 | ◯ | 1.56 |
| Example 3 | 1230 | ◯ | 1.72 |
| Example 4 | 1220 | ◯ | 1.83 |
| Example 5 | 1220 | ◯ | 1.96 |
| Example 6 | 1240 | ◯ | 1.12 |
| Example 7 | 1240 | ◯ | 1.26 |
| Example 8 | 1240 | ◯ | 1.39 |
| Example 9 | 1230 | ◯ | 1.54 |
| Example 10 | 1230 | ◯ | 1.63 |
| Comparative Example 1 | 1250 | X | 0.5 |
| Comparative Example 2 | 1250 | X | 0.76 |
| Comparative Example 3 | 1250 | X | 0.80 |
| Comparative Example 4 | 1250 | X | 0.88 |
| Comparative Example 5 | 1240 | X | 1 (reference) |
| Comparative Example 6 | 1240 | X | 1 |

Referring to Table 2, Examples 1 to 10, which had a higher Sn content on the interface than in the central part in the internal electrode layer and a higher Bi content on the interface than in the central part in the dielectric layer, exhibited all excellent density and reliability, compared with Comparative Examples 1 to 6, which did not include either one of Sn and Bi.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a plurality of dielectric layers and a plurality of internal electrode layers stacked along a stacking direction, wherein at least one dielectric layer among the dielectric layers is interposed therebetween adjacent internal electrode layers among the internal electrode layers; and
an external electrode disposed on an outer surface of the capacitor body,
wherein at least one of the internal electrode layers include tin (Sn),
the at least one dielectric layer includes an element (X), where the element (X) is at least one selected from bismuth (Bi), aluminum (Al), gallium (Ga), and indium (In),
a content of tin (Sn) is higher at an interface of the at least one of the internal electrode layers with the at least one dielectric layer than at a center region of the at least one of the internal electrode layers in the stacking direction, and
a content of the element (X) is higher at the interface than at a center region of the at least one dielectric layer in the stacking direction.

2. The multilayer ceramic capacitor of claim 1, wherein
the interface includes tin (Sn) in a form of SnO₂.

3. The multilayer ceramic capacitor of claim 1, wherein
the at least one of the internal electrode layers further includes nickel (Ni).

4. The multilayer ceramic capacitor of claim 3, wherein
the interface includes the element (X) in a form of an intermetallic compound with nickel (Ni).

5. The multilayer ceramic capacitor of claim 1, wherein
the at least one of the internal electrode layers further includes nickel (Ni),
the interface includes tin (Sn) in a form of SnO₂, and
the interface includes the element (X) in a form of an intermetallic compound with nickel (Ni).

6. The multilayer ceramic capacitor of claim 1, wherein
the at least one of the internal electrode layers further includes the element (X).

7. The multilayer ceramic capacitor of claim 6, wherein
in the at least one of the internal electrode layers, a content of the element (X) is higher at the interface than at the center region of the at least one of the internal electrode layers in the stacking direction.

8. The multilayer ceramic capacitor of claim 1, wherein
the at least one dielectric layer further includes tin (Sn).

9. The multilayer ceramic capacitor of claim 8, wherein
in the at least one dielectric layer, a content of tin (Sn) is higher at the interface than at the center region of the at least one dielectric layer in the stacking direction.

10. The multilayer ceramic capacitor of claim 1, wherein
when analyzing a transmission electron microscope-energy dispersive spectroscopy (TEM-EDS) line along a straight line from a point on the at least one dielectric layer to a point on an internal electrode layer adjacent to the at least one dielectric layer,
atomic % of tin (Sn) has a maximum value at the interface.

11. The multilayer ceramic capacitor of claim 1, wherein
when analyzing a transmission electron microscope-energy dispersive spectroscopy (TEM-EDS) line along a straight line from a point on the at least one dielectric layer to a point on an internal electrode layer adjacent to the at least one dielectric layer,
atomic % of bismuth (Bi) has a maximum value at the interface.

12. The multilayer ceramic capacitor of claim 1, wherein
an average thickness of the interface is 0.01 nm to 100 nm.

13. The multilayer ceramic capacitor of claim 1, wherein
the at least one dielectric layer further includes a barium titanate-based compound, and
the barium titanate-based compound includes at least one selected from BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, and (Ba, Sr)(Ti, Sn)O₃.

14. The multilayer ceramic capacitor of claim 1, wherein
the at least one dielectric layer includes pores with an area of less than 1% per an area of 5 μm×5 μm within the at least one dielectric layer.

15. A method of manufacturing a multilayer ceramic capacitor, comprising
mixing barium titanate-based main component powder and subcomponent powder to prepare a dielectric slurry;
preparing a conductive paste by mixing nickel (Ni) and tin (Sn)-containing compound;
manufacturing a dielectric green sheet from the dielectric slurry and applying the conductive paste on a surface of the dielectric green sheet to form a conductive paste layer;
manufacturing a dielectric green sheet stack by stacking a plurality of the dielectric green sheet on which the conductive paste layer is formed;
manufacturing a capacitor body including a dielectric layer and an internal electrode layer by firing the dielectric green sheet stack; and
forming an external electrode on one surface of the capacitor body,
wherein the subcomponent powder includes at least one selected from a bismuth (Bi)-containing compound, an aluminum (Al)-containing compound, a gallium (Ga)-containing compound, and an indium (In)-containing compound,
the internal electrode layer includes tin (Sn), the dielectric layer include an element (X), where the element (X) is at least one selected from bismuth (Bi), aluminum (Al), gallium (Ga), and indium (In), and
a content of tin (Sn) is higher at an interface of the internal electrode layer with the dielectric layer than at a center region of the internal electrode layer in a stacking direction, and a content of the element (X) is higher at the interface than at a center region of the dielectric layer in the stacking direction.

16. The method of claim 15, wherein
the tin (Sn)-containing compound includes an oxide, a nitride, or a salt compound, or
the tin (Sn)-containing compound includes a sol form dispersed in an organic solvent.

17. The method of claim 15, wherein
the bismuth (Bi)-containing compound, the aluminum (Al)-containing compound, the gallium (Ga)-containing compound, and the indium (In)-containing compound each includes an oxide, a nitride, or a salt compound, or
the bismuth (Bi)-containing compound, the aluminum (Al)-containing compound, the gallium (Ga)-containing compound, and the indium (In)-containing compound each includes a sol form dispersed in an organic solvent.

18. The method of claim 15, wherein
the tin (Sn)-containing compound is mixed with nickel (Ni) in an amount of greater than 0.1 parts by mole and less than or equal to 5 parts by mole based on 100 parts by mole of the barium titanate-based main component powder.

19. The method of claim 15, wherein
the subcomponent powder is mixed in an amount of greater than 0.1 parts by mole and less than or equal to 5 parts by mole based on 100 parts by mole of the barium titanate-based main component powder.

20. The method of claim 15, wherein
a molar ratio of the subcomponent powder to the tin (Sn)-containing compound is 0.1 to 1.
